(19) United States
(12) Patent Application Publication
(10) Pub. No.: US 2026/0368875 A1
(43) Pub. Date: Nov. 19, 2026

(54) THREE-DIMENSIONAL CRACK MEASUREMENT RESEARCH METHOD AND SYSTEM BASED ON MULTI-COORDINATE SYSTEM FUSION

(71) Applicants: Ministry of Water Resources, Ministry of Transport, National Energy Administration, Nanjing Institut, Nanjing (CN); Nanjing University of Science and Technology, Nanjing (CN)

(72) Inventors: Huadeng LI, Nanjing (CN); Yu HU, Nanjing (CN); Beixiao SHI, Nanjing (CN); Mingheng SHAO, Nanjing (CN); Qiming ZHONG, Nanjing (CN); Yong DING, Nanjing (CN); Xin XU, Nanjing (CN); Yujie CAI, Nanjing (CN); Guirong ZHANG, Nanjing (CN); Ning HE, Nanjing (CN); Zhangchun WANG, Nanjing (CN); Ge CHEN, Nanjing (CN); Qiuyang PEI, Nanjing (CN); Yang KONG, Nanjing (CN); Bin HE, Nanjing (CN); Yanzhang ZHOU, Nanjing (CN); Jufu MEI, Nanjing (CN); Xian ZHANG, Nanjing (CN); Zhongyi LIU, Nanjing (CN); Chuan SHI, Nanjing (CN); Ruiqi TAN, Nanjing (CN); Xinran LI, Nanjing (CN); Chengjie SONG, Nanjing (CN)

(73) Assignees: Ministry of Water Resources, Ministry of Transport, National Energy Administration, Nanjing Institut, Nanjing (CN); Nanjing University of Science and Technology, Nanjing (CN)

(21) Appl. No.: 19/334,294

(22) Filed: Sep. 19, 2025

(30) Foreign Application Priority Data
May 12, 2025 (CN) 2025106019739

(51) Int. Cl. G06T 7/00; G06T 5/20; G06T 5/80; G06T 7/13; G06T 7/33; G06T 7/73

(52) U.S. Cl. CPC G06T 7/0002; G06T 5/20; G06T 5/80; G06T 7/13; G06T 7/337; G06T 7/74; G06T 2207/10028; G06T 2207/30184; G06T 2207/30244

(57) ABSTRACT

A three-dimensional crack measurement research method and system based on multi-coordinate system fusion, which relates to the technical field of earth-rock dam monitoring. The method includes: shooting concentric circle target images through a monocular camera at multiple angles, extracting feature points after preprocessing, and correcting projection distortion of non-parallel shooting; establishing a mapping relationship between pixel and three-dimensional coordinate systems to optimize camera pose parameters; reconstructing a three-dimensional coordinate point cloud based on multi-view data, filtering outliers and fitting plane optimization data; registering the three-dimensional point cloud to a world coordinate system through a coordinate system conversion algorithm, and calculating three-dimensional displacement of a crack by comparing two measurement results.

### INCORPORATION BY REFERENCE

This application claims priority to China Patent Application Number 2025106019739 filed May 12, 2025, the contents of which are hereby incorporated by reference in their entirety.

### TECHNICAL FIELD

The present disclosure relates to the technical field of earth-rock dam monitoring, and in particular, to a three-dimensional crack measurement research method and system based on multi-coordinate system fusion.

### BACKGROUND

Cracks are a main evaluation indicator of structural safety, and information collection is often done manually. The accuracy of the measurement results is difficult to guarantee, and the time and labor costs are high. With the development of computer technology, a three-dimensional (3D) measurement technology has begun to be used in long-term detection of the cracks to determine their development status. Zhang Haoyu et al. established a three-dimensional model through deep learning to achieve three-dimensional measurement of cracks. To improve efficiency, Xue Zhilin proposed a three-dimensional displacement measurement method based on stereo vision in a dual coordinate system. Hu Henan extracted long- and short-range time domain features, integrated motion characteristics and depth information, and used deep learning to calculate the three-dimensional displacement of objects. Huang Youchao used binocular cameras to establish an equivalent model and constructed a crack measurement system. These methods either have requirements on sample size and long calculation time, or have requirements on equipment and shooting posture, and are not well adapted to on-site crack measurement.

### SUMMARY

In order to overcome the shortcomings of the existing technologies, the present disclosure aims to provide a three-dimensional crack measurement research method and system based on multi-coordinate system fusion. By specifying a world coordinate system, the present disclosure is designed to establish a connection between the world coordinate system and a pixel coordinate system, solve a relative pose between cameras, and perform three-dimensional reconstruction to avoid a problem of missing depth information in monocular vision. By establishing an equivalent model of three-dimensional displacement of a crack, changes of sub-plate coordinates in the world coordinate system are observed to realize three-dimensional displacement measurement of the crack.

To achieve the above purpose, the present disclosure provides the following solutions.

A three-dimensional crack measurement research method based on multi-coordinate system fusion includes:
taking two target arrangement photos from different positions through a same camera to obtain initial images;
performing binarization and filtering processing on the initial images to obtain preprocessed images;
extracting concentric circle edge information in the preprocessed images and acquiring an initial feature point set through a density-based spatial clustering algorithm;
performing distortion correction on the initial feature point set based on cross-ratio invariance to eliminate an elliptical projection error caused by non-parallel shooting to obtain a corrected feature point set;
performing preliminary calculation of rotation matrixes and translation vectors of the two times of shooting, optimizing a reprojection error to below a threshold of 0.1 in combination with a Levenberg-Marquardt method, and outputting a projection matrix;
based on an intrinsic parameter matrix of camera calibration and the projection matrix, using a least square method to solve an initial three-dimensional coordinate point set under a camera coordinate system;
pre-screening three-dimensional point cloud data in the initial three-dimensional coordinate point set through a random sampling consensus algorithm, eliminating outliers in combination with principal component analysis, iteratively fitting a plane and performing projection, and generating an optimized three-dimensional coordinate point set; and
using an iterative nearest point algorithm based on mean square error optimization to perform point cloud registration according to the optimized three-dimensional coordinate point set, converting three-dimensional coordinates under the camera coordinate system to a world coordinate system, and calculating three-dimensional displacement changes of a crack through a difference between two measurement results.

Preferably, a target is a preset concentric circle target, and a center point set of a concentric circle is used as the feature point set.

Preferably, the performing preliminary calculation of rotation matrixes and translation vectors of the two times of shooting, optimizing a reprojection error to below a threshold of 0.1 in combination with a Levenberg-Marquardt method, and outputting a projection matrix includes:
establishing a mapping relationship between the world coordinate system and a pixel coordinate system through an EPnP algorithm, and solving the rotation matrixes Rₗ, Rᵣ and the translation vectors tₗ, tᵣ under left and right camera coordinate systems;
substituting Rₗ, Rᵣ, tₗ, and tᵣ into a formula

$$\{ \begin{matrix}R = {R}_{r} {t}^{- 1} \\ t = {t}_{r} - {Rt}_{l}\end{matrix}$$

to associate the left and right camera coordinate systems to obtain a relative rotation matrix and a translation vector R and a translation vector t between the left and right camera coordinate systems; and

iteratively optimizing R and t through the Levenberg-Marquardt method until a reprojection error is less than 0.1, and outputting a projection matrix M.

Preferably, an expression of the mapping relationship between the world coordinate system and the pixel coordinate system is as follows:

$${z}_{c} [ \begin{matrix}u \\ v \\ 1\end{matrix} ] = KP [ \begin{matrix}{x}_{w} \\ {y}_{w} \\ {z}_{w} \\ 1\end{matrix} ] ;$$

where, x_{w}, y_{w}, and z_{w}, are X-axis, Y-axis, and Z-axis coordinate values of a point D(x_{w},y_{w},z_{w}) under the world coordinate system, u and v are X-axis and Y-axis coordinate values of a point P(u,v) under the pixel coordinate system, Zc is a Z-axis coordinate value under the camera coordinate system, K is the intrinsic parameter matrix of the camera, and P is the feature point set.

Preferably, the step of iteratively fitting a plane includes:
using an RANSAC algorithm to randomly select three points to establish an initial plane model, and screening inliers within a distance threshold of 0.5;
refitting plane parameters based on the least square method, and performing ten iterations to complete preliminary fitting; and
eliminating outliers whose distances to adjacent points exceed a limit through a PCA algorithm, and performing reprojection onto a fitting plane until distance thresholds of all the points in the plane are less than 0.3 or the iteration diverges.

Preferably, the using an iterative nearest point algorithm based on mean square error optimization to perform point cloud registration according to the optimized three-dimensional coordinate point set, converting three-dimensional coordinates under the camera coordinate system to a world coordinate system, and calculating three-dimensional displacement changes of a crack through a difference between two measurement results includes:
based on the generated optimized three-dimensional coordinate point set P_{w}, calculating centroids P_{c} and

$${P}_{c}^{′}$$

of three-dimensional points under the camera coordinate system and the target world coordinate system respectively;
according to the centroids P_{c} and

$${P}_{c}^{′} ,$$

performing de-centroid processing on each point to obtain de-centroid coordinates Qᵢ and

$${Q}_{i}^{′} ,$$

where, Qᵢ=Pᵢ−P_{c} and

$${Q}_{i}^{′} = {P}_{i}^{′} - {P}_{c}^{′} ,$$

and Pᵢ and

$${P}_{i}^{′}$$

are an actually observed two-dimensional image point and an obtained two-dimensional image point respectively;
constructing a covariance matrix W, and performing singular value decomposition on W to obtain a decomposition result, where,

$$W = {\sum }_{i = 1}^{n} {Q}_{i} {Q}_{i}^{T} ;$$

a formula of the decomposition result is: SVD(W)=UΣV^{T}; and U and V are a left singular vector and a right singular vector respectively;
calculating an optimal rotation matrix R′ and a translation vector t′ according to the decomposition result, where, a calculation formula of the optimal rotation matrix R′ is: R′=VU^{T}, and the translation vector

$${t}^{′} = {P}_{c} - R \cdot {P}_{c}^{′} ;$$

converting the solved three-dimensional coordinate point set under the camera coordinate system to the world coordinate system through the optimal rotation matrix R′ and translation vector t′ to obtain a converted coordinate point set

$${P}_{w}^{′} ;$$

calculating a root mean square error RMSE between the optimized three-dimensional coordinate point set P_{W} and the converted coordinate point set

$${P}_{w}^{′} ;$$

a formula of RMSE being

$$RMSE = \sqrt{\frac{1}{2} {\sum }_{i = 1}^{n} ( {d}_{i}^{2} )} ,$$

where,

$${d}_{i} = {P}_{i} - {Q}_{i} = \sqrt{{( {x}_{i} - {x}_{i}^{′} )}^{2} + {( {y}_{i} - {y}_{i}^{′} )}^{2} + {( {z}_{i} - {z}_{i}^{′} )}^{2}} ,$$

dᵢ is a distance between the i-th point in a source point cloud and the corresponding point in a target point cloud, and n is the total number of matching point pairs; and
iterating the optimal rotation matrix R′ and the translation vector t′ until the RMSE is less than the threshold of 0.1 or the iteration diverges, and finally outputting a crack displacement variation under the world coordinate system.

Preferably, a calculation formula of the crack displacement variation is:

$$[ \begin{matrix}Δ X \\ Δ Y \\ Δ Z\end{matrix} ] = [ \begin{matrix}{X}_{i}^{′} - {X}_{i} \\ {Y}_{i}^{′} - {Y}_{i} \\ {Z}_{i}^{′} - {Z}_{i}\end{matrix} ] ,$$

where,

$$[ \begin{matrix}Δ X \\ Δ Y \\ Δ Z\end{matrix} ]$$

is the crack displacement variation, ΔX, ΔY and ΔZ are the X-axis, Y-axis, and Z-axis coordinate values of the crack displacement variation,

$${X}_{i}^{′} , {Y}_{i}^{′} and {Z}_{i}^{′}$$

are three-dimensional coordinates of the crack after the change; Xᵢ, Yᵢ and Zᵢ are three-dimensional coordinates of the crack before the change.

A three-dimensional crack measurement research system based on multi-coordinate system fusion includes:
an image input unit configured to take two target arrangement photos from different positions through a same camera to obtain initial images;
an image preprocessing unit configured to perform binarization and filtering processing on the initial images to obtain preprocessed images;
a density clustering unit configured to extract concentric circle edge information in the preprocessed images and acquire an initial feature point set through a density-based spatial clustering algorithm;
a circle center correction unit configured to perform distortion correction on the initial feature point set based on cross-ratio invariance to eliminate an elliptical projection error caused by non-parallel shooting to obtain a corrected feature point set;
a pose solving unit configured to perform preliminary calculation of rotation matrixes and translation vectors of the two times of shooting, optimize a reprojection error to below a threshold of 0.1 in combination with a Levenberg-Marquardt method, and output a projection matrix;
a coordinate solving unit configured to, based on an intrinsic parameter matrix of camera calibration and the projection matrix, use a least square method to solve an initial three-dimensional coordinate point set under a camera coordinate system;
a plane fitting unit configured to pre-screen three-dimensional point cloud data in the initial three-dimensional coordinate point set through a random sampling consensus algorithm, eliminate outliers in combination with principal component analysis, iteratively fit a plane and perform projection, and generate an optimized three-dimensional coordinate point set; and
a coordinate system conversion unit configured to use an iterative nearest point algorithm based on mean square error optimization to perform point cloud registration according to the optimized three-dimensional coordinate point set, convert three-dimensional coordinates under the camera coordinate system to a world coordinate system, and calculate three-dimensional displacement changes of a crack through a difference between two measurement results.

According to the specific embodiments provided by the present disclosure, the present disclosure discloses the following technical effects.

The present disclosure provides a three-dimensional crack measurement research method and system based on multi-coordinate system fusion. The method includes: taking two target arrangement photos from different positions through a same camera to obtain initial images; performing binarization and filtering processing on the initial images to obtain preprocessed images; extracting concentric circle edge information in the preprocessed images and acquiring an initial feature point set through a density-based spatial clustering algorithm; performing distortion correction on the initial feature point set based on cross-ratio invariance to eliminate an elliptical projection error caused by non-parallel shooting to obtain a corrected feature point set; performing preliminary calculation of rotation matrixes and translation vectors of the two times of shooting, optimizing a reprojection error to below a threshold of 0.1 in combination with a Levenberg-Marquardt method, and outputting a projection matrix; based on an intrinsic parameter matrix of camera calibration and the projection matrix, using a least square method to solve an initial three-dimensional coordinate point set under a camera coordinate system; pre-screening three-dimensional point cloud data in the initial three-dimensional coordinate point set through a random sampling consensus algorithm, eliminating outliers in combination with principal component analysis, iteratively fitting a plane and performing projection, and generating an optimized three-dimensional coordinate point set; and using an iterative nearest point algorithm based on mean square error optimization to perform point cloud registration according to the optimized three-dimensional coordinate point set, converting three-dimensional coordinates under the camera coordinate system to a world coordinate system, and calculating three-dimensional displacement changes of a crack through a difference between two measurement results. By specifying a world coordinate system, the present disclosure aims to establish a connection between the world coordinate system and a pixel coordinate system, solve a relative pose between cameras, and perform three-dimensional reconstruction to avoid a problem of missing depth information in monocular vision. By establishing an equivalent model of three-dimensional displacement of a crack, changes of sub-plate coordinates in the world coordinate system are observed to realize three-dimensional displacement measurement of the crack.

### BRIEF DESCRIPTION OF DRAWINGS

In order to more clearly illustrate the embodiments of the present disclosure or the technical solutions in the existing technologies, the following briefly introduces the accompanying drawings required for use in embodiments. Obviously, the accompanying drawings described below are only some embodiments of the present disclosure. For those of ordinary skill in the art, other drawings can be obtained based on these accompanying drawings without paying any creative work.

FIG. 1 is a flow chart of a method provided by an embodiment of the present disclosure;

FIG. 2 is a flow chart of an algorithm provided by an embodiment of the present disclosure;

FIG. 3 is a diagram of a plane fitting result provided by an embodiment of the present disclosure;

FIG. 4 is a diagram of target arrangement provided by an embodiment of the present disclosure;

FIG. 5 is a flow chart of pose iteration solution provided by an embodiment of the present disclosure;

FIG. 6 shows three-axis displacement variations in X-axis unidirectional movement test results provided by an embodiment of the present disclosure;

FIG. 7 shows three-axis error values in X-axis unidirectional movement test results provided by an embodiment of the present disclosure;

FIG. 8 shows X-axis movement stability in X-axis unidirectional movement test results provided by an embodiment of the present disclosure;

FIG. 9 shows three-axis displacement variations in Y-axis unidirectional movement test results provided by an embodiment of the present disclosure;

FIG. 10 shows three-axis error values in Y-axis unidirectional movement test results provided by an embodiment of the present disclosure;

FIG. 11 shows Y-axis movement stability in Y-axis unidirectional movement test results provided by an embodiment of the present disclosure;

FIG. 12 shows three-axis displacement variations in Z-axis unidirectional movement test results provided by an embodiment of the present disclosure;

FIG. 13 shows three-axis error values in Z-axis unidirectional movement test results provided by an embodiment of the present disclosure;

FIG. 14 shows Z-axis movement stability in Z-axis unidirectional movement test results provided by an embodiment of the present disclosure;

FIG. 15 shows three-axis displacement variations in test results of simultaneous movement of X, Y, and Z axes provided by an embodiment of the present disclosure; and

FIG. 16 shows three-axis error values in test results of simultaneous movement of X, Y, and Z axes provided by an embodiment of the present disclosure.

### DETAILED DESCRIPTION OF EMBODIMENTS

The technical solutions in embodiments of the present disclosure will be clearly and completely described below in conjunction with the drawings in the embodiments of the present disclosure. Obviously, the described embodiments are only part of the embodiments of the present disclosure, rather than all the embodiments. Based on the embodiments of the present disclosure, all other embodiments obtained by those of ordinary skill in the art without making any creative work shall fall within the scope of protection of the present disclosure.

The present disclosure aims to provide a three-dimensional crack measurement research method and system based on multi-coordinate system fusion. By specifying a world coordinate system, the present disclosure is designed to establish a connection between the world coordinate system and a pixel coordinate system, solve a relative pose between cameras, and perform three-dimensional reconstruction to avoid a problem of missing depth information in monocular vision. By establishing an equivalent model of three-dimensional displacement of a crack, changes of sub-plate coordinates in the world coordinate system are observed to realize three-dimensional displacement measurement of the crack.

In order to make the above-mentioned objects, features and advantages of the present disclosure more obvious and easy to understand, the present disclosure is further described in detail below with reference to the accompanying drawings and specific implementations.

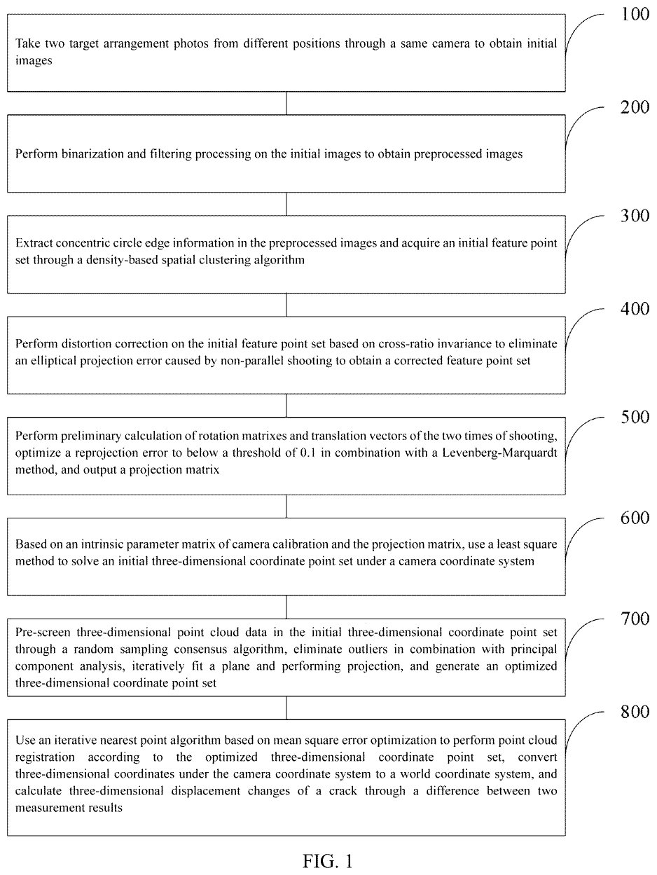

FIG. 1 is a flow chart of a method provided by an embodiment of the present disclosure. As shown in FIG. 1, the present disclosure provides a three-dimensional crack measurement research method based on multi-coordinate system fusion, which includes:
step 100: taking two target arrangement photos from different positions through a same camera to obtain initial images;
step 200: performing binarization and filtering processing on the initial images to obtain preprocessed images;
step 300: extracting concentric circle edge information in the preprocessed images and acquiring an initial feature point set through a density-based spatial clustering algorithm;
step 400: performing distortion correction on the initial feature point set based on cross-ratio invariance to eliminate an elliptical projection error caused by non-parallel shooting to obtain a corrected feature point set;
step 500: performing preliminary calculation of rotation matrixes and translation vectors of the two times of shooting, optimizing a reprojection error to below a threshold of 0.1 in combination with a Levenberg-Marquardt method, and outputting a projection matrix;
step 600: based on an intrinsic parameter matrix of camera calibration and the projection matrix, using a least square method to solve an initial three-dimensional coordinate point set under a camera coordinate system;
step 700: pre-screening three-dimensional point cloud data in the initial three-dimensional coordinate point set through a random sampling consensus algorithm, eliminating outliers in combination with principal component analysis, iteratively fitting a plane and performing projection, and generating an optimized three-dimensional coordinate point set; and
step 800: using an iterative nearest point algorithm based on mean square error optimization to perform point cloud registration according to the optimized three-dimensional coordinate point set, converting three-dimensional coordinates under the camera coordinate system to a world coordinate system, and calculating three-dimensional displacement changes of a crack through a difference between two measurement results.

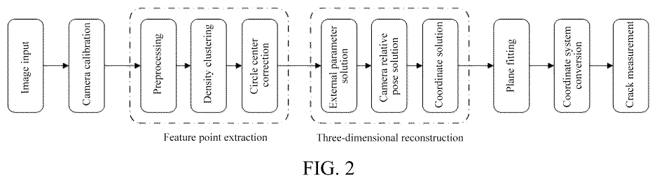

Specifically, as shown in FIG. 2, the present disclosure provides a three-dimensional crack measurement research method based on multi-coordinate system fusion, which includes the following steps:
1) image input: taking two target arrangement photos from different positions through a same camera;
2) image preprocessing: first, performing preprocessing such as binarization and image filtering on images;
3) density clustering: then, using a canny operator to extract concentric circle edge information for density clustering, and using DBSCAN density clustering to find a center of concentric circles to form an initial feature point set P′;
4) circle center correction: since on-site shooting is often not parallel, the circle on an object plane will appear as an ellipse when projected onto an image plane, resulting in an error between the circle center and the actual circle center and an actual projection point, namely eccentricity errors. To eliminate the eccentricity errors, this embodiment uses cross-ratio invariance to correct the circle center for distortion. After sorting, a feature point set P={(u₁, v₁), (u₂, v₂), (u₃, v₃) . . . } can be formed;
5) computer relative position solution: first, using an EPnP algorithm to preliminarily obtain a rotation matrix R and a translation vector t required for coordinate system conversion, solving pi, tl, Rr and tr of two times of shooting are obtained; then, using a Levenberg-Marquardt method to optimize the rotation matrix R and displacement t vector of the camera, stopping iteration until a reprojection error value is less than a given threshold 0.1, and outputting a projection matrix M is output;
6) coordinate solution: according to the solved feature point set P=(u₁, v₁), (u₂, v₂), (u₃, v₃) . . . }, an intrinsic parameter matrix K obtained by camera calibration, and the projection matrix M obtained in step 5, using a least square method to solve a three-dimensional coordinate point set in a camera coordinate system;
7) plane fitting: since pose derivation is based on ideal conditions, after three-dimensional reconstruction, the obtained coordinate point set must be optimized to eliminate influences of interference items such as noise. Considering that a target plane is basically horizontal, the three-dimensional point set obtained by theoretical solution should also be located in the same lane. Therefore, plane fitting is used to compensate for image distortion.

$${P}_{c}^{′}$$

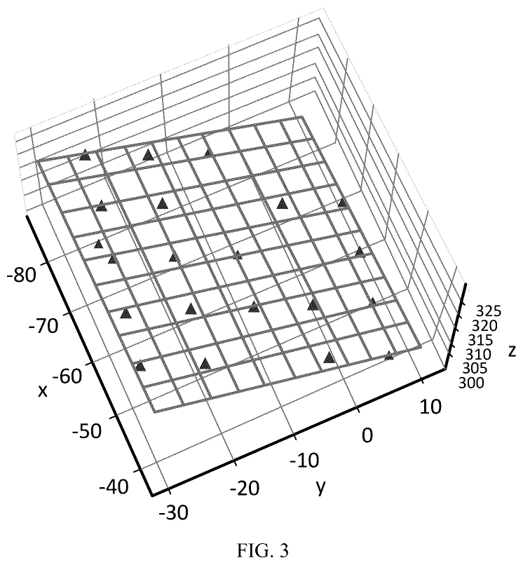

is projected onto the fitting plane to form a new data point set P_{c}. Subsequently, P_{c} is converted into the world coordinate system through an ICP algorithm and iterative optimization based on a mean square error, and finally the optimized three-dimensional coordinate point set P_{w}=[(X₀, Y₀, Z₀), (X₁, Y₁, Z₁), (X₂, Y₂, Z₂) . . . ] is obtained. The plane fitting results are shown in FIG. 3; and
8) coordinate system conversion: the ICP algorithm based on mean square error iterative optimization is used for point cloud registration to solve the pose and coordinates under the camera coordinate system are converted into a conversion relationship of the coordinates under the world coordinate system. The coordinate P_{w}(P_{w}=RP_{c}+t) under the world coordinate system is solved. According to coordinates of the right target measured twice in sequence, P_{w1}=[X₀, Y₀, Z₀] and

$${P}_{0}^{′} = [ {X}_{0}^{′} , {Y}_{0}^{′} , {Z}_{0}^{′} ]$$

are subtracted, so the three-dimensional displacement changes of the crack can be obtained.

$$[ \begin{matrix}Δ X \\ Δ Y \\ Δ Z\end{matrix} ] = [ \begin{matrix}{X}_{i}^{′} - {X}_{i} \\ {Y}_{i}^{′} - {Y}_{i} \\ {Z}_{i}^{′} - {Z}_{i}\end{matrix} ] ,$$

where,

$$[ \begin{matrix}Δ X \\ Δ Y \\ Δ Z\end{matrix} ]$$

is the crack displacement variation, ΔX, ΔY and ΔZ are X-axis, Y-axis and Z-axis coordinate values of a crack displacement variation,

$${X}_{i}^{′} , {Y}_{i}^{′} and {Z}_{i}^{′}$$

are three-dimensional coordinates of the crack after the change; Xᵢ, Yᵢ and Zᵢ are three-dimensional coordinates of the crack before the change.

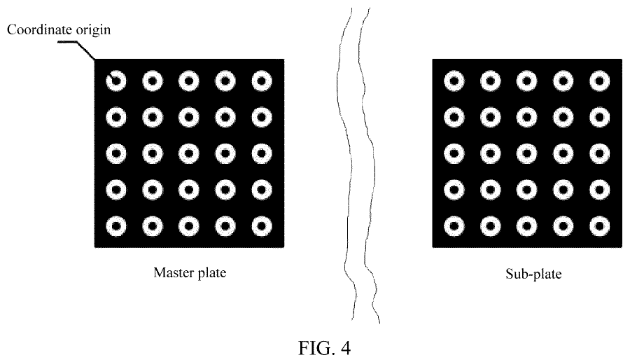

Further, in step 1), as for the target arrangement photos, in this embodiment, concentric circle targets are independently designed, and the concentric center point set is used as the feature point set. On the one hand, the feature point extraction accuracy can be improved by constraints of the concentric circles. On the other hand, the error caused by feature point matching errors can be eliminated by sorting. The target arrangement diagram is shown in FIG. 4.

Further, in step 5), during camera imaging, given an arbitrary point P in space, two views in left and right camera coordinate systems can be associated using Pₗ=R^{T}(Pᵣ−t). The following relationship is obtained:

$$\{ \begin{matrix}R = {R}_{t} {t}^{- 1} \\ t = {t}_{r} - {Rt}_{l}\end{matrix} ,$$

where, Pₗ, Pᵣ respectively represent a position of point P in the left and right camera coordinate systems; Rₗ and tₗ or (Rᵣ and tᵣ) represent a rotation matrix and a translation vector from the camera to the spatial point P on the left camera (right camera); R and t are the relative rotation matrix and translation vector between the left and right camera coordinate systems. Rₗ, tₗ, Rᵣ, tᵣ, obtained above are substituted to solve a posture relationship, thereby forming the projection matrix M(M=K·Rt)

Further, in step 6), the coordinate conversion relationship between the point D(x_{w},y_{w},z_{w}) under the world coordinate system and the point P(u,v) under the pixel coordinate system is as follows:

$${z}_{c} [ \begin{matrix}u \\ v \\ 1\end{matrix} ] = KP [ \begin{matrix}{x}_{w} \\ {y}_{w} \\ {z}_{w} \\ 1\end{matrix} ] ,$$

where, K is an intrinsic parameter matrix of the camera, and Zc is the coordinate of the Z axis under the camera coordinate system.

Further, in step 6), in order to prevent the plane fitting from falling into a local optimum, this embodiment uses an RANSAC algorithm for pre-fitting before plane fitting to screen point cloud data. First, a plane is established by randomly selecting three points in the point cloud data, and distances between all points in the point cloud set and the plane model are calculated, and 0.5 is used as a threshold determination boundary. When the number of internal points of the model meets the requirements, all points on the plane (local points) are configured to recalculate the plane parameters based on the least squares principle V^{T}PV=min. In this way, ten iterations are performed to complete preliminary fitting.

Further, after the RANSAC pre-fitting in step 7), the PCA algorithm is configured to eliminate points that are far away from adjacent points in the three-dimensional point cloud with reference to actual distances set by the target, and then plane fitting is performed again. After fitting is completed, the originally eliminated points are re-projected onto the fitting plane. Iterates are performed until the distances between all points in the plane and the plane are less than the set threshold 0.3 or the iteration situation diverges. After the fitting is completed, a new set P_{c}=P_{C1},P_{C2}, P_{C3} . . . } of coordinate points can be obtained.

Further, in step 8), the specific steps of pose solution are as follows:
1) calculating centroids P_{c} and

$${P}_{c}^{′}$$

of three-dimensional points in two different coordinate systems respectively;
2) calculating de-centroid coordinates

$${Q}_{i} = {P}_{i} - {P}_{c} , {Q}_{i}^{′} = {P}_{i}^{′} - {P}_{c}^{′}$$

of each point separately;
3) defining the matrix

$$W = {\sum }_{i = 1}^{n} {Q}_{i} {Q}_{i}^{T}$$

and then performing SVD decomposition SVD(W)=UΣV^{T} on the matrix;
4) when W is full rank, performing calculation to obtain R=UV^{T},

$$t = {P}_{c} - R \cdot {P}_{c}^{′} ;$$

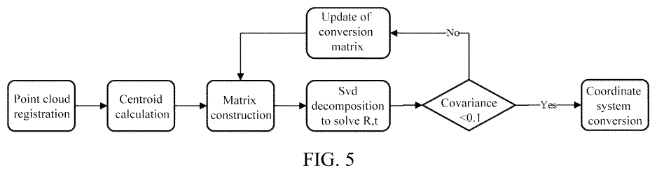

5) calculating a root mean square error:

$$RMSE = \sqrt{\frac{1}{n} {\sum }_{i = 1}^{n} ( {d}_{i}^{2} )} ,$$

$${d}_{i} = {P}_{i} - {Q}_{i} = \sqrt{{( {x}_{i} - {x}_{i}^{′} )}^{2} + {( {y}_{i} - {y}_{i}^{′} )}^{2} + {( {z}_{i} - {z}_{i}^{′} )}^{2}} ,$$

where, dᵢ is the distance between the i-th point in a source point cloud and the corresponding point in the target point cloud, and n is the total number of matching point pairs; and
6) setting a root mean square threshold to 0.1, iteratively converting the matrix until the threshold is less than 0.1 or the iteration situation diverges, and stopping the iteration. The iteration flow chart is shown in FIG. 5.

Further, the three-dimensional crack measurement research method based on multi-coordinate system fusion proposed by the present disclosure has the characteristics of high detection accuracy and wider applicability compared with existing solutions.

As an optional implementation, this embodiment uses a camera for multi-angle shooting to fit a shooting process of a binocular camera. After obtaining two pictures, the pictures are input into a computer terminal, required test parameters are calculated, and finally test results are obtained. The camera model is Nikon D3100, with 14.2 million pixels, 4608×3702 effective pixels, an image processor EXPEED 2 with a sensor size of 23.1×15.4 mm, and a focal length of 18-55 mm.

To verify the accuracy and stability of the algorithm, this embodiment designs a three-dimensional displacement accuracy and stability detection device based on a fixed slide. The device consists of a horizontal axis slide, a longitudinal slide, a vertical slide and a dial indicator. Left and right test targets are fixed on the movable end and the fixed end respectively, an electronic dial indicator is arranged in the sliding horizontal direction, and the targets are moved by the slide rail to simulate the three-dimensional changes of the crack.

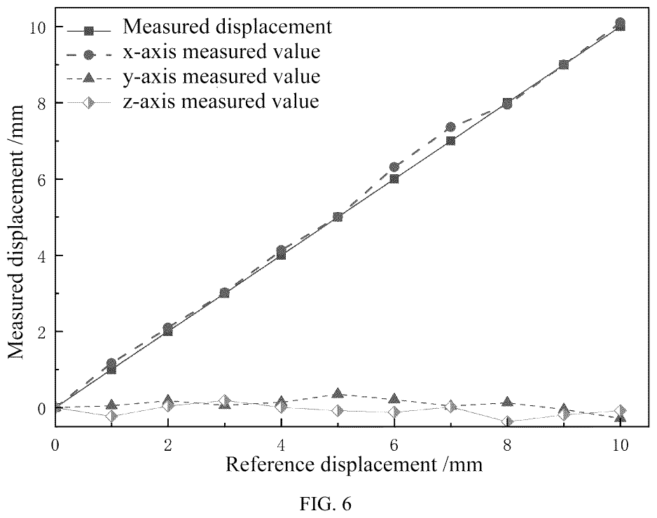

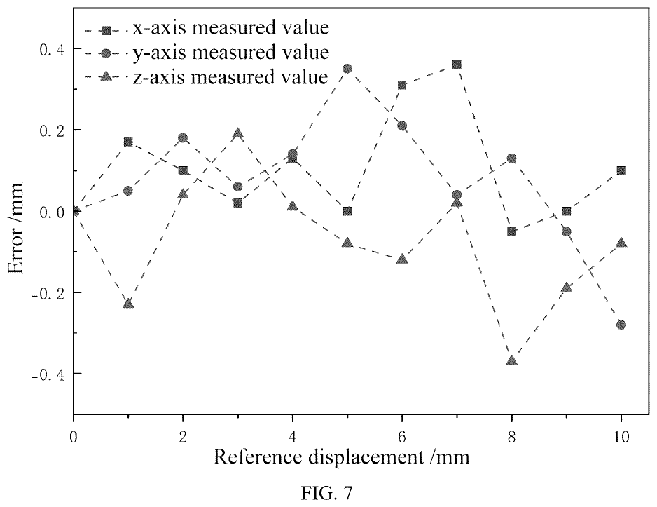

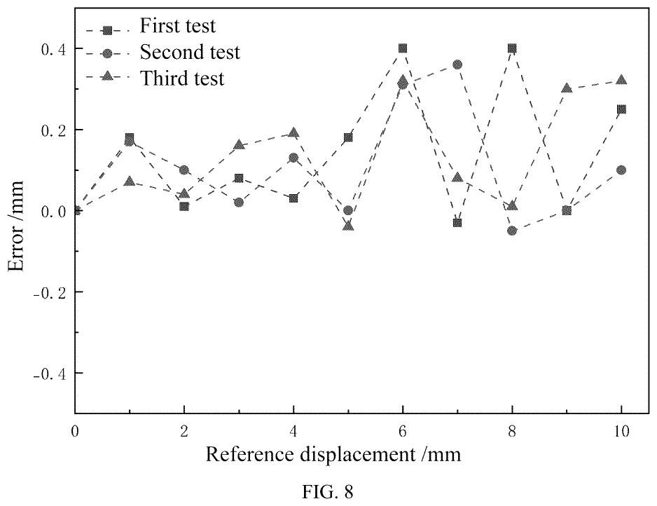

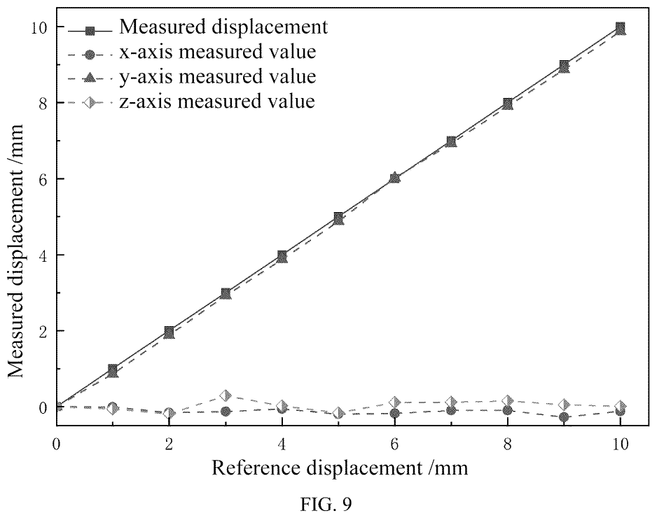

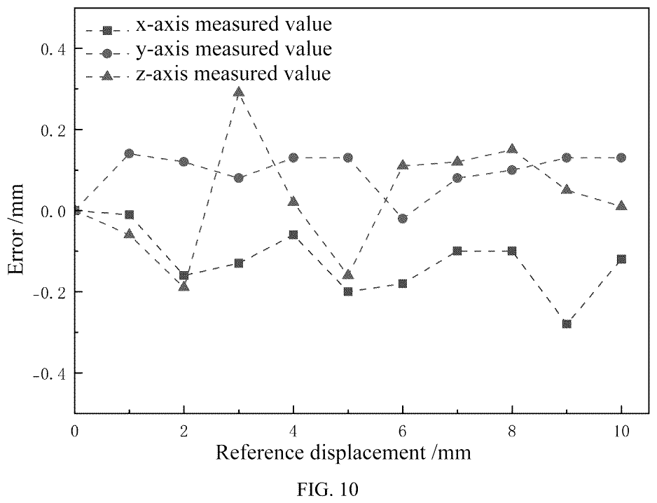

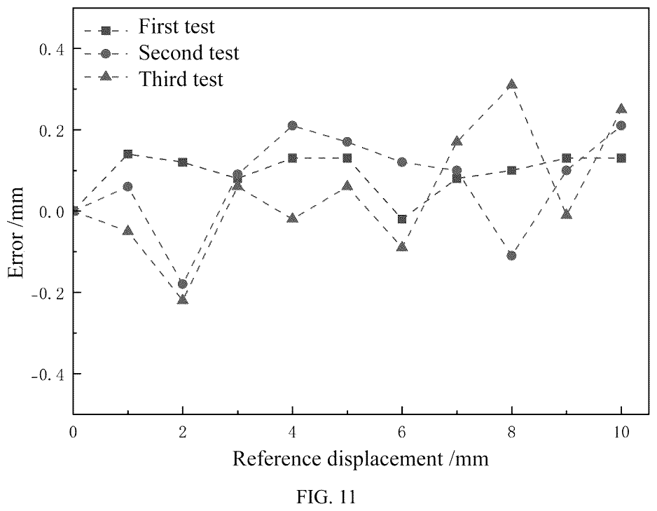

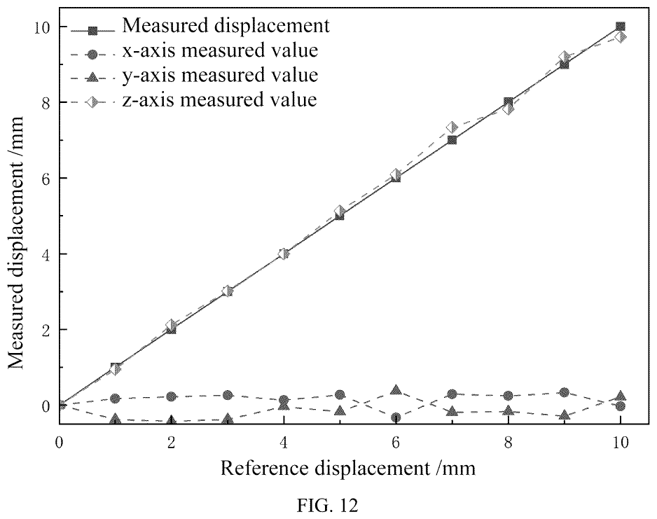

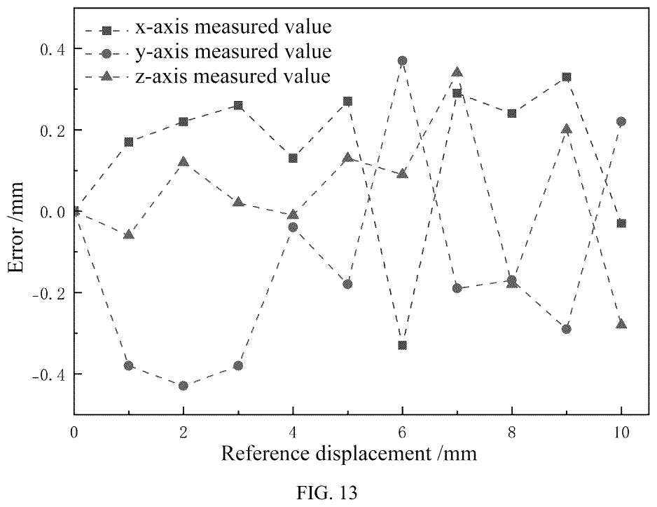

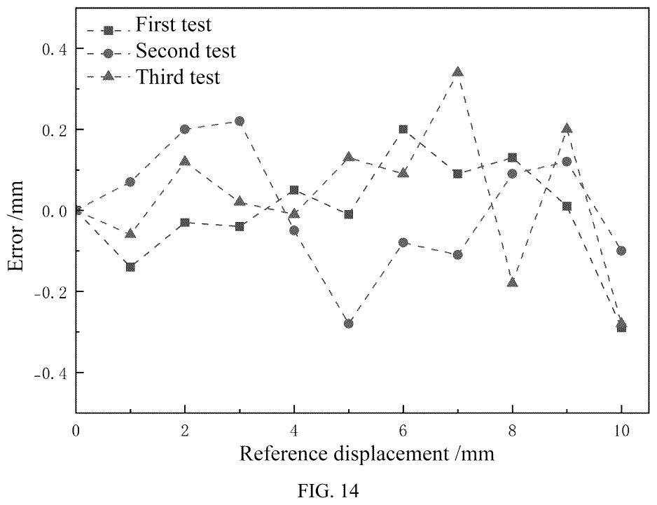

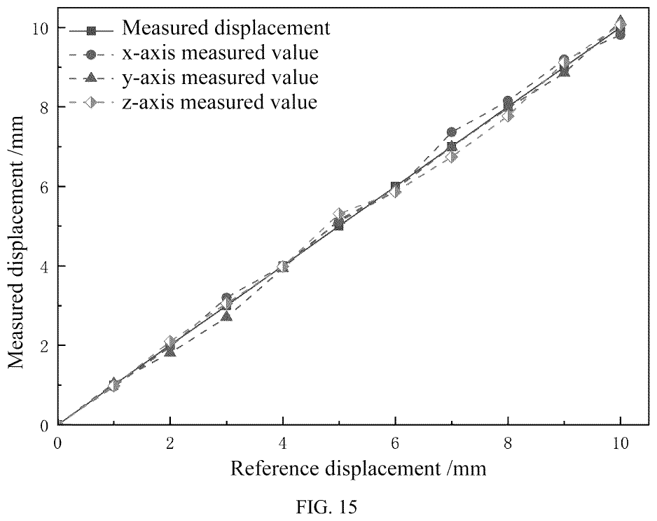

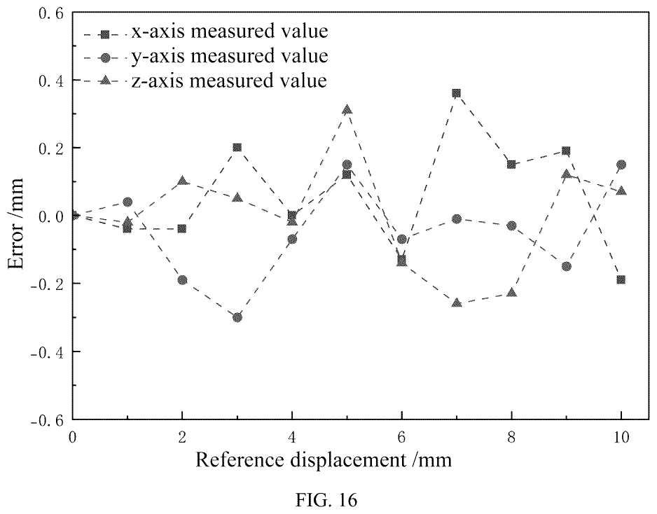

During the test, the camera is used to shoot the test equipment from multiple angles, the target is placed in the center as much as position during shooting. In this embodiment, the target at the movable end is moved to simulate the relative displacement between the two sides of the crack, and the reading of the electronic dial indicator is used as a reference value of the displacement. During the test, the displacement is controlled at 1 mm each time, and a total of ten movements are made. Images are collected after each movement for data processing. The difference between the obtained three-dimensional coordinates and the coordinates at the time of initial shooting is the change in the crack. The test results are shown in FIG. 6 to FIG. 16. As shown in FIG. 6 to FIG. 8, when the X-axis is moved unidirectionally, the error between the measured displacement and the actual displacement is controlled within ±0.4 mm. At the same time, the error range in the X direction is within ±0.4 mm, indicating that the accuracy and stability of the algorithm are reliable, and the error volatility does not increase with the increase of the reference displacement. As shown in FIG. 9 to FIG. 11, when the Y-axis is moved unidirectionally, the error between the measured displacement and the actual displacement is controlled within ±0.4 mm. At the same time, the error range in the Y direction is within ±0.4 mm, indicating that the accuracy and stability of the algorithm are reliable, and the error volatility does not increase with the increase of the reference displacement. As shown in FIG. 12 to FIG. 14, when the Z-axis is moved unidirectionally, the error between the measured displacement and the actual displacement is controlled within ±0.4 mm. At the same time, the error range in the Z direction is within ±0.4 mm, indicating that the accuracy and stability of the algorithm are reliable, and the error volatility does not increase with the increase of the reference displacement. Since cracks may not only undergo unidirectional displacement in actual situations, three-axis movement tests are also necessary. FIG. 15 and FIG. 16 show the test results when the three axes X, Y, and Z are moved simultaneously. As shown in FIG. 15 and FIG. 16, when the three axes are moved, the error between the measured displacement and the actual displacement is controlled within ±0.4 mm. At the same time, the three-dimensional error range is within ±0.4 mm, indicating that the accuracy and stability of the algorithm are reliable; and the error variation range of each axis is within the same level, indicating that the algorithm measurement effect is good.

Analysis of the above test results shows that in the single-axis movement test, the displacement distance of the moving axis measured by the algorithm shows a linear change trend with the actual movement distance, and the absolute error of the fixed axis remains at a level close to that of the measuring axis, fluctuating within ±0.4 mm, indicating that the algorithm can accurately judge the changes in the moving axis. During the three-axis movement test, the error remains at ±0.4 mm.

The algorithm analysis of this embodiment is as follows:

TABLE 1
Algorithm Resolution Analysis

Measuring axis

| Evaluation criteria | x | y | z |
|---|---|---|---|
| Fluctuation range (mm) | −0.2-+0.4 | −0.3-+0.2 | ±0.3 |

As shown in Table 1, the three-axis measurement fluctuation range of the algorithm is within 0.6 mm, which proves that the resolution of the algorithm is within the controllable range.

TABLE 2
Algorithm Accuracy Analysis

Measuring axis

| Evaluation criteria | x | y | z |
|---|---|---|---|
| Absolute error (mm) | ±0.4 | ±0.4 | ±0.4 |

As shown in Table 2, during the test, the absolute errors of the three axes are all within ±0.4 mm, which meet the requirements for crack measurement in the Technical Specifications for Safety Monitoring of Earth-Rock Dams (±0.5 mm).

TABLE 3
Algorithm Repeatability Analysis

Measuring axis

| Evaluation criteria | x | y | z |
|---|---|---|---|
| Maximum deviation (mm) | 0.4 | 0.3 | −0.3 |

As shown in Table 3, the maximum deviation of the algorithm is 0.4 mm on the x-axis, which proves that the repeatability of this embodiment is reliable.

Corresponding to the above method, this embodiment further provides a three-dimensional crack measurement research system based on multi-coordinate system fusion, which includes:
an image input unit configured to take two target arrangement photos from different positions through a same camera to obtain initial images;
an image preprocessing unit configured to perform binarization and filtering processing on the initial images to obtain preprocessed images;
a density clustering unit configured to extract concentric circle edge information in the preprocessed images and acquire an initial feature point set through a density-based spatial clustering algorithm;
a circle center correction unit configured to perform distortion correction on the initial feature point set based on cross-ratio invariance to eliminate an elliptical projection error caused by non-parallel shooting to obtain a corrected feature point set;
a pose solving unit configured to perform preliminary calculation of rotation matrixes and translation vectors of the two times of shooting, optimize a reprojection error to below a threshold of 0.1 in combination with a Levenberg-Marquardt method, and output a projection matrix;
a coordinate solving unit configured to, based on an intrinsic parameter matrix of camera calibration and the projection matrix, use a least square method to solve an initial three-dimensional coordinate point set under a camera coordinate system;
a plane fitting unit configured to pre-screen three-dimensional point cloud data in the initial three-dimensional coordinate point set through a random sampling consensus algorithm, eliminate outliers in combination with principal component analysis, iteratively fit a plane and perform projection, and generate an optimized three-dimensional coordinate point set; and
a coordinate system conversion unit configured to use an iterative nearest point algorithm based on mean square error optimization to perform point cloud registration according to the optimized three-dimensional coordinate point set, convert three-dimensional coordinates under the camera coordinate system to a world coordinate system, and calculate three-dimensional displacement changes of a crack through a difference between two measurement results.

The beneficial effects of the present disclosure are as follows.

(1) First, by specifying the world coordinate system, the EPnP algorithm establishes the association between the world coordinate system and the pixel coordinate system, solves the relative pose between the cameras, and performs three-dimensional reconstruction, thereby avoiding the problem of missing depth information in monocular vision. The present disclosure solves the problem that traditional crack detection methods have high requirements for equipment and shooting poses and cannot be well adapted to on-site crack measurement.

(2) Secondly, the present disclosure independently designs the concentric circle target and uses the concentric center point set as the feature point set. On the one hand, the feature point extraction accuracy can be improved by the constraints of the concentric circle itself, and on the other hand, the error caused by the feature point matching error can be eliminated by sorting.

(3) The present disclosure designs a concentric dot matrix target and establishes a crack equivalent displacement model, thereby converting the three-dimensional crack change measurement problem into the relative change measurement problem of the target main plate and the sub-plate. The feature point set is obtained by camera shooting. Through three-dimensional reconstruction and coordinate system conversion, the sub-plate point set is transferred to the world coordinate system. By observing the changes in the sub-plate coordinates, the three-dimensional changes of the crack can be known. The problem of lack of depth information in monocular vision measurement and the failure to use the same to quickly and accurately calculate the three-dimensional displacement of cracks is solved.

The embodiments in this specification are described in a progressive manner, and each embodiment focuses on the differences from other embodiments. The same or similar parts between the embodiments can be referenced to each other. As for the system disclosed in the embodiment, since the system corresponds to the method disclosed in the embodiment, the description is relatively simple, and the relevant parts can be referred to the description of the method part.

This article uses specific examples to illustrate the principles and implementations of the present disclosure. The description of the above embodiments is only configured to help understand the method and core ideas of the present disclosure. At the same time, for those of ordinary skill in the art, according to the concept of the present disclosure, there may be changes in the specific implementations and application scope. In summary, the contents of this specification should not be understood as limiting the present disclosure.

What is claimed is:

1. A three-dimensional crack measurement research method based on multi-coordinate system fusion, comprising:
taking two target arrangement photos from different positions through a same camera to obtain initial images;
performing binarization and filtering processing on the initial images to obtain preprocessed images;
extracting concentric circle edge information in the preprocessed images and acquiring an initial feature point set through a density-based spatial clustering algorithm;
performing distortion correction on the initial feature point set based on cross-ratio invariance to eliminate an elliptical projection error caused by non-parallel shooting to obtain a corrected feature point set;
performing preliminary calculation of rotation matrixes and translation vectors of the two times of shooting, optimizing a reprojection error to below a threshold of 0.1 in combination with a Levenberg-Marquardt method, and outputting a projection matrix;
based on an intrinsic parameter matrix of camera calibration and the projection matrix, using a least square method to solve an initial three-dimensional coordinate point set under a camera coordinate system;
pre-screening three-dimensional point cloud data in the initial three-dimensional coordinate point set through a random sampling consensus algorithm, eliminating outliers in combination with principal component analysis, iteratively fitting a plane and performing projection, and generating an optimized three-dimensional coordinate point set;
using an iterative nearest point algorithm based on mean square error optimization to perform point cloud registration according to the optimized three-dimensional coordinate point set, converting three-dimensional coordinates under the camera coordinate system to a world coordinate system, and calculating three-dimensional displacement changes of a crack through a difference between two measurement results;
the performing preliminary calculation of rotation matrixes and translation vectors of the two times of shooting, optimizing a reprojection error to below a threshold of 0.1 in combination with a Levenberg-Marquardt method, and outputting a projection matrix comprising:
establishing a mapping relationship between the world coordinate system and a pixel coordinate system through an EPnP algorithm, and solving the rotation matrixes Rₗ, Rᵣ and the translation vectors tₗ, tᵣ under left and right camera coordinate systems;
substituting Rₗ, Rᵣ, tₗ, and tᵣ into a formula
$$\{ \begin{matrix}R = {R}_{r} {t}^{- 1} \\ t = {t}_{r} - {Rt}_{l}\end{matrix}$$
to associate the left and right camera coordinate systems to obtain a relative rotation matrix and a translation vector R and a translation vector t between the left and right camera coordinate systems;
iteratively optimizing R and t through the Levenberg-Marquardt method until a reprojection error is less than 0.1, and outputting a projection matrix M;
an expression of the mapping relationship between the world coordinate system and the pixel coordinate system being as follows:
$${z}_{c} [ \begin{matrix}u \\ v \\ 1\end{matrix} ] = KP [ \begin{matrix}{x}_{w} \\ {y}_{w} \\ {z}_{w} \\ 1\end{matrix} ]$$
wherein x_{w}, y_{w}, and z_{w}, are X-axis, Y-axis, and Z-axis coordinate values of a point D(x_{w},y_{w},z_{w}) under the world coordinate system, u and v are X-axis and Y-axis coordinate values of a point P(u,v) under the pixel coordinate system, Zc is a Z-axis coordinate value under the camera coordinate system, K is the intrinsic parameter matrix of the camera, and P is the feature point set;
using an iterative nearest point algorithm based on mean square error optimization to perform point cloud registration according to the optimized three-dimensional coordinate point set, converting three-dimensional coordinates under the camera coordinate system to a world coordinate system, and calculating three-dimensional displacement changes of a crack through a difference between two measurement results comprising:
based on the generated optimized three-dimensional coordinate point set P_{w}, calculating centroids P_{c} and
$${P}_{c}^{′}$$
of three-dimensional points under the camera coordinate system and the target world coordinate system respectively;
according to the centroids P_{c} and
$${P}_{c}^{′} ,$$
performing de-centroid processing on each point to obtain de-centroid coordinates Qᵢ and
$${Q}_{i}^{′} ,$$
where, Qᵢ=Pᵢ−P_{c} and
$${Q}_{i}^{′} = {P}_{i}^{′} - {P}_{c}^{′} , and {P}_{i} and {P}_{i}^{′}$$
are an actually observed two-dimensional image point and an obtained two-dimensional image point respectively;
constructing a covariance matrix W, and performing singular value decomposition on W to obtain a decomposition result, where,
$$W = {\sum }_{i = 1}^{n} {Q}_{i} {Q}_{i}^{T} ;$$
a formula of the decomposition result is: SVD(W)=UΣV^{T}; and U and V are a left singular vector and a right singular vector respectively;
calculating an optimal rotation matrix R′ and a translation vector t′ according to the decomposition result, where, a calculation formula of the optimal rotation matrix R′ is: R′=VU^{T} and the translation vector
$${t}^{′} = {P}_{c} - R \cdot {P}_{c}^{′} ;$$
converting the solved three-dimensional coordinate point set under the camera coordinate system to the world coordinate system through the optimal rotation matrix R′ and translation vector t′ to obtain a converted coordinate point set
$${P}_{w}^{′} ;$$
calculating a root mean square error RMSE between the optimized three-dimensional coordinate point set P_{W} and the converted coordinate point set
$${P}_{w}^{′} ;$$
a formula of RMSE being
$$RMSE = \sqrt{\frac{1}{n} {\sum }_{i = 1}^{n} ( {d}_{i}^{2} )} ,$$
where,
$${d}_{i} = {P}_{i} - {Q}_{i} = \sqrt{{( {x}_{i} - {x}_{i}^{′} )}^{2} + {( {y}_{i} - {y}_{i}^{′} )}^{2} + {( {z}_{i} - {z}_{i}^{′} )}^{2}} ,$$
dᵢ is a distance between the i-th point in a source point cloud and the corresponding point in a target point cloud, and n is the total number of matching point pairs; and
iterating the optimal rotation matrix R′ and the translation vector t′ until the RMSE is less than the threshold of 0.1 or the iteration diverges, and finally outputting a crack displacement variation under the world coordinate system;
a calculation formula of the crack displacement variation being:
$$[ \begin{matrix}Δ X \\ Δ Y \\ Δ Z\end{matrix} ] = [ \begin{matrix}{X}_{i}^{′} - {X}_{i} \\ {Y}_{i}^{′} - {Y}_{i} \\ {Z}_{i}^{′} - {Z}_{i}\end{matrix} ] ,$$
wherein
$$[ \begin{matrix}Δ X \\ Δ Y \\ Δ Z\end{matrix} ]$$
is the crack displacement variation, ΔX, ΔY and ΔZ are the X-axis, Y-axis, and Z-axis coordinate values of the crack displacement variation,
$${X}_{i}^{′} , {Y}_{i}^{′} and {Z}_{i}^{′}$$
are three-dimensional coordinates of the crack after the change; Xᵢ, Yᵢ and Zᵢ are three-dimensional coordinates of the crack before the change.

2. The three-dimensional crack measurement research method based on multi-coordinate system fusion according to claim 1, wherein a target is a preset concentric circle target, and a center point set of a concentric circle is used as the feature point set.

3. The three-dimensional crack measurement research method based on multi-coordinate system fusion according to claim 1, wherein the step of iteratively fitting a plane comprises:
using an RANSAC algorithm to randomly select three points to establish an initial plane model, and screening inliers within a distance threshold of 0.5;
refitting plane parameters based on the least square method, and performing ten iterations to complete preliminary fitting; and
eliminating outliers whose distances to adjacent points exceed a limit through a PCA algorithm, and performing reprojection onto a fitting plane until distance thresholds of all the points in the plane are less than 0.3 or the iteration diverges.

4. A three-dimensional crack measurement research system based on multi-coordinate system fusion, wherein the system is configured to implement the method according to claim 1, and the system comprises:
an image input unit configured to take two target arrangement photos from different positions through a same camera to obtain initial images;
an image preprocessing unit configured to perform binarization and filtering processing on the initial images to obtain preprocessed images;
a density clustering unit configured to extract concentric circle edge information in the preprocessed images and acquire an initial feature point set through a density-based spatial clustering algorithm;
a circle center correction unit configured to perform distortion correction on the initial feature point set based on cross-ratio invariance to eliminate an elliptical projection error caused by non-parallel shooting to obtain a corrected feature point set;
a pose solving unit configured to perform preliminary calculation of rotation matrixes and translation vectors of the two times of shooting, optimize a reprojection error to below a threshold of 0.1 in combination with a Levenberg-Marquardt method, and output a projection matrix;
a coordinate solving unit configured to, based on an intrinsic parameter matrix of camera calibration and the projection matrix, use a least square method to solve an initial three-dimensional coordinate point set under a camera coordinate system;
a plane fitting unit configured to pre-screen three-dimensional point cloud data in the initial three-dimensional coordinate point set through a random sampling consensus algorithm, eliminate outliers in combination with principal component analysis, iteratively fit a plane and perform projection, and generate an optimized three-dimensional coordinate point set; and
a coordinate system conversion unit configured to use an iterative nearest point algorithm based on mean square error optimization to perform point cloud registration according to the optimized three-dimensional coordinate point set, convert three-dimensional coordinates under the camera coordinate system to a world coordinate system, and calculate three-dimensional displacement changes of a crack through a difference between two measurement results.
